(19) United States
(12) Patent Application Publication
(10) Pub. No.: US 2003/0023535 A1
(43) Pub. Date: Jan. 30, 2003

(54) Methods and systems for management of investment pool inflows and outflows

(76) Inventor: Michael C. Hoffman, San Francisco, CA (US)

Correspondence Address: KIRKPATRICK & LOCKHART LLP, 535 SMITHFIELD STREET, PITTSBURGH, PA, 15222, US

(21) Appl. No.: 10/226,940

(22) Filed: Aug. 23, 2002

(51) Int. Cl. G06F 17/60

(52) U.S. Cl. 705/36

(57) ABSTRACT

In one embodiment of the present methods and systems, a method is provided for assisting at least one investment pool with managing flows of the investment pool. The method includes selling a security to the investment pool; receiving an amount of assets of the investment pool as payment for the security; and performing at least one of a subscription transaction and a redemption transaction for the investment pool using at least a portion of the payment. System and computer-readable media embodiments associated with various embodiments and aspects of the present methods are also provided.

### BACKGROUND

Generally, an investment pool is a group of assets that is invested with one or more defined investment objectives. The pool is typically comprised of assets of numerous investors with an investment manager controlling the investments of the pooled assets.

A mutual fund is one type of investment pool that offers investors the opportunity to invest in shares of an underlying group of investments. Typically, each mutual fund has an investment strategy by which it abides in selecting the instruments in which it invests. For example, a mutual fund that is described in the context of the Standard & Poor's 500 Index usually invests a portion of its assets in the securities that comprise that index.

Shareholders or investors in mutual funds transact in mutual funds by exchanging cash or its equivalent for shares of a mutual fund. This exchange can be done using various methods including, but not limited to, transacting directly with a mutual fund company or transacting though a securities broker or other intermediary. Generally, upon a purchase of mutual fund shares by an investor, the mutual fund issues to the investor a number of shares equivalent to the value of the assets transferred to the fund divided by the current share price of the fund. If a mutual fund is a closed-end fund, it may issue a limited number of shares for sale. By contrast, if a mutual fund is an open-end fund, it may issue an unlimited number of shares to potential investors.

Different investors invest in mutual funds for a variety of reasons and with a variety of time horizons for their mutual fund investments. At least some investors who purchase mutual funds may desire to invest on a long-term basis and are more interested in long-term appreciation than daily values. Other mutual fund investors may base their trades on a quantitative model that determines when the investor will buy and sell shares of the mutual fund. Still other investors in mutual funds may desire a short-term investment that involves purchasing shares of a mutual fund on a given trading day, for example, and subsequently selling those same mutual fund shares on a following trading day. The typically low or free cost of transacting in a mutual fund makes it an attractive investment vehicle for short-term and active traders.

On any given day, a mutual fund receives orders to purchase shares and orders to sell shares. Typically, a mutual fund issues new shares of the fund to meet each subscription order and pays out mutual fund assets in the form of cash to meet each redemption order. If the mutual fund does not have sufficient cash to meet the total amount of redemption requests, a fund manager may be forced to sell a portion of the underlying mutual fund investments to generate sufficient cash to satisfy the redemption requests. In the event that the dollar amount of subscriptions exceeds the dollar amount of redemptions, the mutual fund receives new cash that may be used for investment by the mutual fund in accordance with the investment strategy outlined in the fund prospectus. Generally, the total net inflow or total net outflow of a mutual fund can be calculated by adding the value of the subscription orders (as a positive number representing inflow) to the value of the redemption orders (as a negative number representing outflow). If a mutual fund experiences a net inflow (i.e., more subscriptions than redemptions) on one trading day, it is possible that the mutual fund will experience a net outflow (i.e., more redemptions than subscriptions) on a following trading day.

It can be appreciated that frequent subscription and redemption activity can have possibly harmful financial effects on a mutual fund and its shareholders. Frequent trading activity may cause a mutual fund manager difficulty in managing the assets and investments of the mutual fund. Most mutual funds maintain a certain percentage of assets in cash for, among other things, meeting redemption requests from mutual fund investors. Often, mutual fund managers prefer to minimize this cash balance, so that a greater percentage of the mutual fund assets may be invested in accordance with the investment strategy of the mutual fund. When a mutual fund manager must hold a relatively high cash position to meet subscriptions and redemptions, the performance of the mutual fund may decrease as some securities, such as equity products, historically produce higher rates of return than cash. When a mutual fund manager is forced to transact in the underlying investments of the mutual fund due to subscription and redemption activity, the fund may incur increased expenses such as, for example, commissions on securities trades, bid/ask spreads, and other costs. In addition, when a mutual fund manager sells securities as a result of subscription and redemption transactions, the mutual fund typically realizes capital gains that may result in negative tax consequences for the shareholders of the fund.

Therefore, when mutual funds experience excessive subscription and redemption activity, mutual fund shareholders can be negatively financially affected in the form of higher operational costs and lower fund performance. For example, as a fund experiences frequent subscription or redemption requests, longer-term mutual fund shareholders lose returns on their mutual fund investments since aggregate trades and related transactions costs are increased.

Improved methods and systems are needed for monitoring, processing, and analyzing subscription and redemption transactions in association with management of mutual fund assets. Improved methods and systems are also needed to analyze, manage and reduce the negative effects of fluctuations in the assets of mutual funds. In addition, improved methods and systems are needed to reduce costs associated with mutual fund transactions in order to benefit both the mutual fund as a whole and its individual investors.

### SUMMARY

In one embodiment of the present methods and systems, a method is provided for assisting at least one investment pool with managing flows of the investment pool. The method includes selling a security to the investment pool; receiving an amount of assets of the investment pool as payment for the security; and performing at least one of a subscription transaction and a redemption transaction for the investment pool using at least a portion of the payment.

In another embodiment of the present methods and systems, a method is provided for assisting an investment pool with managing flows of the investment pool. The method includes selling a security to the investment pool, wherein a rate of return of the security is equal to a percentage of a rate of return of the investment pool; and, receiving an amount of assets of the investment pool as payment for the security.

In another embodiment of the present methods and systems, a method is provided for managing flows of two or more investment pools. The method includes selling a first security to a first investment pool having assets, wherein the rate of return of the first security is equal to a percentage of a rate of return of the first investment pool; receiving an amount of the assets of the first investment pool as payment in exchange for the first security; selling at least a second security to at least a second investment pool having assets, wherein a rate of return of the second security is equal to a percentage of a rate of return of the second investment pool; and, receiving an amount of the assets of the second investment pool as payment in exchange for the second security.

In another embodiment of the present methods and systems, a method is provided, in an investment pool, for managing flows of the investment pool. The method includes purchasing a security from a financial service provider, the security having a rate of return equal to a percentage of a rate of return of the investment pool; and, distributing a payment to the financial service provider in exchange for receiving the security, the payment including an amount of assets of the investment pool.

In another embodiment of the present methods and systems, a method is provided for assisting a plurality of mutual funds with managing flows associated with the mutual funds. The method includes purchasing a security from each of the mutual funds, the security having a rate of return equal to a percentage of a rate of return of a collective investment pool; and, distributing at least one payment to the collective investment pool in exchange for receiving the security, each the payment including an amount of assets of each of the mutual funds.

In another embodiment of the present methods and systems, a method is provided for offsetting the flows of at least two mutual funds. The method includes performing a redemption transaction of a first mutual fund to offset a flow of the first mutual fund; and, using proceeds from the redemption transaction for performing a subscription transaction for a second mutual fund to offset a flow of the second mutual fund.

System and computer-readable media embodiments associated with various embodiments and aspects of the present methods are also provided herein.

### BRIEF DESCRIPTION OF THE FIGURES

FIG. 1 is a schematic diagram depicting one embodiment of a method and system for assisting with management of the inflows and/or outflows of one or more mutual funds;

FIG. 2 is a process flow diagram showing one embodiment of a method for assisting with management of the inflows and/or outflows of one or more investment pools;

FIG. 3 is a process flow diagram providing more detail of one aspect of the process flow diagram of FIG. 2;

FIG. 4 is a process flow diagram providing more detail of one aspect of the process flow diagram of FIG. 2;

FIG. 5 is a schematic diagram depicting one illustrative embodiment of a system for assisting with management of the inflows and/or outflows of one or more investment pools;

FIG. 6 is a schematic diagram depicting one embodiment of a method for assisting with management of inflows and outflows in accordance with the present methods and systems;

FIGS. 7A and 7B include spreadsheet schematics showing various aspects of an operational example provided in accordance with the present methods and systems;

FIGS. 8A and 8B include spreadsheet schematics showing various aspects of an operational example provided in accordance with the present methods and systems;

FIGS. 9A and 9B include spreadsheet schematics showing various aspects of an operational example provided in accordance with the present methods and systems;

FIG. 10 includes a spreadsheet schematic showing various aspects of an operational example provided in accordance with the present methods and systems;

FIG. 11 is a sample graphical representation displaying a comparison of flows of a fund for a given time period in accordance with practice of the present methods and systems;

FIG. 12 is a sample graphical representation displaying a comparison of flows of a fund for a given time period in accordance with practice of the present methods and systems;

FIG. 13 is a sample graphical representation displaying a comparison of flows of a fund for a given time period in accordance with practice of the present methods and systems;

FIG. 14 is a sample graphical representation displaying a comparison of flows of a fund for a given time period in accordance with practice of the present methods and systems;

FIG. 15 is a sample graphical representation displaying a comparison of flows of a fund for a given time period in accordance with practice of the present methods and systems; and,

FIG. 16 is a sample graphical representation displaying a comparison of flows of a fund for a given time period in accordance with practice of the present methods and systems.

### DESCRIPTION

As applied herein, the term “security” can include a variety of financial instruments that have an associated liability or liabilities. A “security” can include, for example and without limitation, an equity instrument, a debt instrument, a short-term debt instrument, a long-term debt instrument, a convertible equity instrument, a note, a reissued note, a derivative product, a contractual obligation, a service contract, and any other financial instrument that is suitable for use in accordance with the present methods and systems. In one particular example, a “security” includes a five-year duration, pays a variable rate of return equal to the rate of return of a mutual fund, maintains short-term liquidity in the form of the capacity for daily redemption by its holder, and possesses a “AA” credit rating or higher.

Also, as applied herein, the term “investment security” can include a variety of financial instruments. An “investment security” can include, for example and without limitation, an equity instrument, a debt instrument, a short-term debt instrument, a long-term debt instrument, a convertible equity instrument, a note, a reissued note, a derivative product, a contractual obligation, a service contract, and any other financial instrument that is suitable for use as an “investment security” in accordance with the present methods and systems.

As applied herein, the term “investment pool” can include any financial entity suitable for use in association with the present methods and systems. One example of an “investment pool” is a mutual fund type investment pool. For purposes of convenience of illustration, a mutual fund or mutual funds are employed herein, unless otherwise specified, as merely one illustrative type of investment pool suitable for use in connection with practice of the present methods and systems. Other examples of “investment pools” include, without limitation, unit trusts, trust units, unit investment trusts, open-ended investment trusts, and other like financial entities.

As used herein, the term “financial service provider” can include any financial entity suitable for use in association with the present methods and systems. Examples of suitable financial service providers include, for example and without limitation, banks, brokers, broker/dealers, insurance companies, money managers, and the like.

As applied herein, the term “flow” includes any change in assets, such as a change in assets of an investment pool, for example. In various aspects of the present methods and systems, “flow” is expressed as a number or a dollar amount, for example. In some aspects, a negative “flow” for an investment pool, for example, means that at least a portion of the assets of the investment pool (which portion may be expressed as shares, units, or another suitable measurement) have been redeemed, included in a redemption transaction, sold, and/or submitted to the investment pool for cash payment or a cash equivalent. In other aspects, a positive “flow” for an investment pool, for example, means that at least a portion of the assets of the investment pool (which portion may be expressed as shares, units, or another suitable measurement) have been subscribed, included in a subscription transaction, purchased, and/or distributed by the investment pool in exchange for cash payment or a cash equivalent.

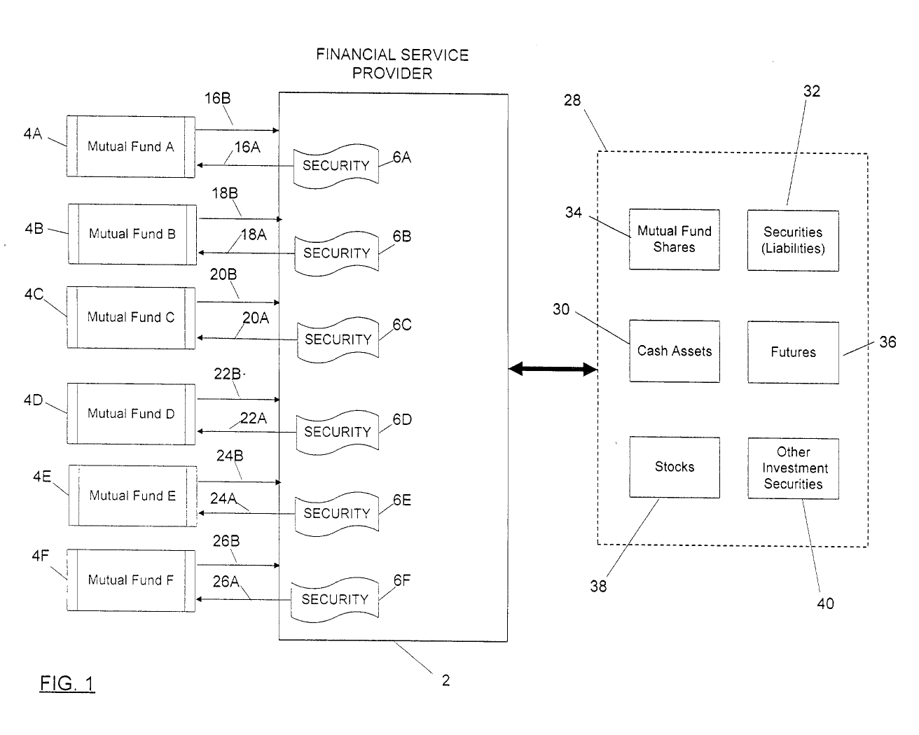

Referring now to FIG. 1, in one embodiment of the present methods and systems, a financial service provider 2 interacts with one or more participating investment pools such as mutual funds 4A-4F. It can be appreciated that mutual funds 4A-4F are shown merely for convenience of disclosure, and that more or less than the number mutual funds illustrated are suitable for use in connection with the present methods and systems. For convenience of disclosure, and where appropriate and applicable, the mutual funds 4A-4F may be referred to as mutual funds 4, collectively, or as mutual fund 4 for a single fund. The mutual funds 4 participate in the services provided by the financial service provider 2. The financial service provider 2 sells securities 6A-6F, respectively, to the participating mutual funds 4A-4F. For convenience of disclosure, and where appropriate and applicable, the securities 6A-6F may be referred to as securities 6, collectively, or as security 6 for a single security. As shown in FIG. 1, the sale of securities 6A-6F to the mutual funds 4A-4F is schematically represented, respectively, by corresponding transactions 16A-26A. The sale of securities 6A-6F occurs in exchange for payment of a portion of the assets of the mutual funds 4A-4F. The payments by the mutual funds 4A-4F to the financial service provider 2 are schematically represented, respectively, by payment transactions 16B-26B. In one aspect, an additional payment can be made by the mutual fund 4 to the financial service provider 2 for performing redemption and subscription services for the mutual fund 4. The additional payment may be based, for example, on a percentage of the amount of subscriptions and redemptions performed by the financial service provider 2 for the mutual fund 4. The additional payment may be made by the mutual fund 4 on a periodic basis such as, for example, weekly, monthly, quarterly, semi-annually, yearly or another suitable period.

In one aspect of the present methods and systems, the financial service provider 2 sells at least one of the securities 6 in exchange for payment of a percentage of the value of the assets of one of the mutual funds 4 up to 10%, for example, of the total value of the mutual fund 4 assets. In one illustrative embodiment, one of the securities 6 can be sold in exchange for payment of 3%, for example, of the value of the assets of one of the participating mutual funds 4. In another aspect of the present methods and systems, the maximum percentage of assets of a given fund 4 that can be sold is governed by applicable local, state and/or federal rules, regulations and/or laws.

In another aspect, each of the securities 6 possesses a variable rate of return related to the rate of return of the particular participating mutual fund 4 to which the security 6 is sold. In another aspect, the rate of return of the security 6 may be equal to the rate of return of the mutual fund 4. In another aspect, the rate of return of the security 6 may be a percentage of the rate of return of the mutual fund 4. In another aspect, the rate of return of the security 6 may be related to the rate of return of one or more activities/entities employed by the mutual funds 4 including, for example, an investment pool formed by the mutual funds 4. In another aspect, the security 6 may maintain a conventional rate of return that is not related to the rate of return of the mutual fund 4 or an activity/entity employed by the mutual funds 4. While only mutual funds 4A-4F are shown in FIG. 1 for convenience of illustration, it can be appreciated that any number of mutual funds can participate in the services offered and provided by the financial service provider 2.

In another aspect of the present methods and systems, the financial service provider 2 maintains a pool of assets and liabilities 28 that includes cash assets 30 derived from the sale of securities 32 (accounted as liabilities) and/or shares 34 of the various participating mutual funds 4 to which securities 6 have been sold. The pool of assets and liabilities 28 can be used by the financial service provider 2 to purchase and/or redeem shares of the mutual funds 4 to which securities 6 have been sold and/or to make other investments pursuant to an investment strategy of the financial service provider 2. In one embodiment, the pool of assets and liabilities 28 may also include an amount of futures 36 or other investment securities to enhance the ability of the financial service provider 2 to offset the flows of the participating mutual funds 4. As shown in FIG. 1, in various aspects, the pool of assets and liabilities 28 may also include an amount of stocks 38, for example, and/or other investment securities 40.

In the course of various market conditions that occur on a given trading day, each participating mutual fund 4 experiences an inflow of cash assets received from investors purchasing shares of the participating mutual fund 4 and/or an outflow of cash assets caused by investors redeeming shares in the mutual fund 4. The financial service provider 2 employs the sale of securities 6 and its pool of assets and liabilities 28 to reduce or eliminate the variations in cash flow occasioned by this subscription and redemption activity by investors and shareholders of the participating mutual funds 4. As discussed hereinafter in more detail, the pool of assets and liabilities 28 can be employed to purchase or redeem shares from the participating mutual funds 4, and thereby offset flows experienced by the mutual funds 4 by allocating resources available in the pool of assets and liabilities 28.

It can be seen that the sale of securities 6 is beneficial to the participating mutual funds 4 for a variety of reasons. Because the securities 6 sold to the participating mutual funds 4, in some aspects of the present methods and systems, are related to the rate of return on investment of the mutual funds 4, managers of the mutual funds 4 can pursue investment strategies in accordance with their regularly planned operation and management of the mutual funds 4. The rate of return of the security 6 is thereby associated with the performance of the mutual fund 4, which is affected by the investment decisions of the manager of the mutual fund 4. In effect, the mutual fund 4 manager has retained a degree of control of the rate of return of the sold assets associated with the security 6 by merely executing a regularly planned investment strategy for the mutual fund 4. In addition, by paying an amount of the assets of the mutual fund 4 in exchange for the security 6, each mutual fund 4 manager has reduced the cash required to meet the flows associated with daily redemptions and subscriptions, and therefore has reduced the opportunity cost to the mutual fund 4 of holding a significant cash position.

It can be appreciated that various beneficial aspects of the present methods and systems can mitigate net flows to mutual funds 4 and other related financial institutions, reduce trading costs paid by mutual funds 4 and other related financial institutions, and reduce the required amount of cash position held by mutual funds 4 and other related financial institutions. Since the financial services provider 2 at least partially offsets daily flows, the mutual fund 4 can decrease or eliminate day-to-day trading requirements. In effect, the mutual fund 4 can transfer day-to-day trading requirements to a longer period (such as monthly, for example) after which the mutual funds 4 and the financial services provider 2 can agree to reset, or rebalance the allocation of the security in order for the financial services provider 2 to be able to continue to offer its beneficial services to mutual fund 4.

Thus, as applied herein, the reset is performed to re-establish a predetermined, acceptable level of assets held by the financial services provider in each of the mutual funds 4. Depending on the volume and type of flow allocations performed by the financial services provider 2 for each mutual fund 4, the reset can be performed at the end of a defined trading period (e.g., after a number of trading days), at any time after any number of flow allocations have been performed for a given mutual fund 4, or at no time after any number of flow allocations have been performed for a given mutual fund 4. In this aspect, trading events involving the assets of the mutual fund 4 can be transformed from short-term events (such as daily events, for example) to longer-term events (such as monthly events, for example) that can be readily monitored, analyzed and managed by a mutual fund 4 manager or other financial professional.

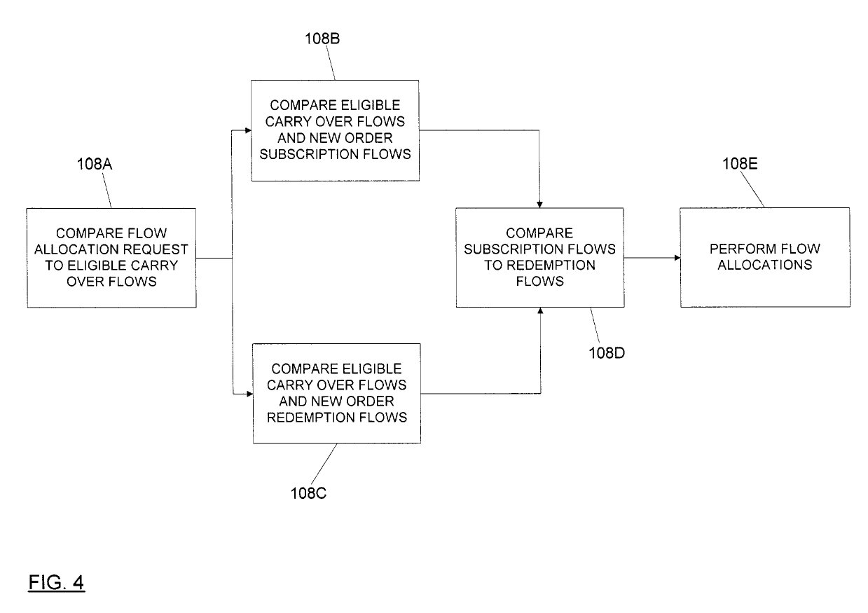

Referring now to FIGS. 1 through 4, in another embodiment of the present methods and systems, a method is illustrated for assisting with management of various inflows and outflows occurring between/among the participating mutual funds 4 and the financial service provider 2. In step 102, the financial service provider 2 receives flow information from the mutual funds 4 including, for example, net flow information for a given trading day, a number of outstanding shares for each mutual fund 4, and other pertinent information communicated by one or more of the participating mutual funds 4A-4F. In one aspect, the flow information can include data related to one or more subscriptions and/or redemptions of shares (and the associated variations in flow caused by that subscription and redemption activity) experienced by the mutual funds 4 during a given trading day. For example, flow information may include net subscription data or net redemption data for a given mutual fund 4 for a particular trading day.

In step 104, eligible inflows and outflows available for allocation by the financial service provider 2 for one or more of the participating mutual funds 4 can be calculated. An “eligible flow” or the “eligibility” of a flow for which allocation is needed can be determined based on a number of factors including, for example and without limitation, the total amount or percentage of assets of a fund held by the financial service provider, an amount of carry over flow for a fund, and/or whether the flow to be allocated represents an inflow or an outflow for the fund.

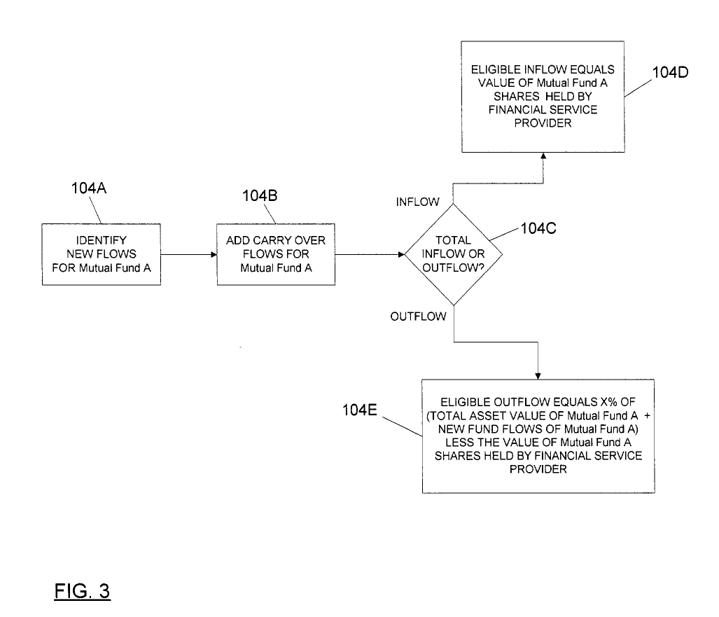

Referring now to FIG. 3, Mutual Fund A is an example of a fund for which eligible inflows and outflows can be calculated. It can be appreciated that flow information for other participating mutual funds 4 can be processed in a manner substantially similar to that of Mutual Fund A by the illustrative method embodiment shown in FIG. 3. Mutual Fund A is presented merely as representative of the mutual funds 4A-4F for purposes of convenience of disclosure and illustration of the one method embodiment shown in FIG. 3.

In step 104A, new inflows and outflows for Mutual Fund A are identified. In step 104B, carry over flows, such as may be calculated and processed from one or more prior trading periods in step 106 (discussed hereinafter in more detail), are added to the flows identified in step 104A. In step 104C, the financial service provider 2 can determine whether the total flow for Mutual Fund A represents a total inflow or a total outflow for Mutual Fund A. If a total inflow is determined to exist in step 104C, then the financial service provider 2 can determine in step 104D that the eligible portion of the total inflow is equal to the value of the shares of Mutual Fund A currently held by the financial service provider 2. If a total outflow is determined to exist in step 104C, then the financial service provider 2 can determine in step 104E that the eligible outflow equals X % of the sum of the total asset value of Mutual Fund A and the new fund flows of Mutual Fund A less the value of Mutual Fund A shares currently held by the financial service provider 2. It can be appreciated that the value of X can be selected to be any percentage value suitable for use in accordance with the present methods and systems. As discussed hereinabove, the selection of X may be impacted by need for compliance with local, state, and/or federal rules, regulations and/or laws.

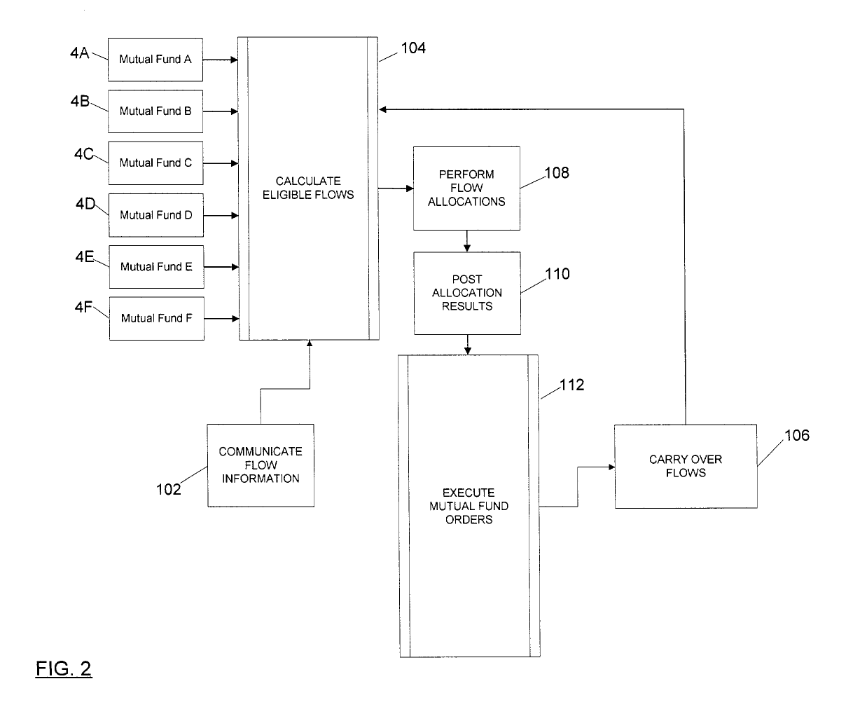

Referring again to FIGS. 1 and 2, in step 108, the financial service provider 2 performs flow allocations to satisfy flow allocation needs of the mutual funds 4 by using assets acquired from the mutual funds 4 in association with the pool of assets and liabilities 28. As discussed hereinabove, securities 6 are sold to the participating mutual funds 4 in exchange for payment of a portion of the assets of the participating mutual funds 4. The proceeds from the securities 6 and the liabilities 32 associated with the securities 6 can be maintained and accessed by the financial service provider 2 in the pool of assets and liabilities 28.

Referring now to FIGS. 1 through 4, in step 108A, the financial service provider 2 compares new flow allocation needs received from the mutual funds 4 (in step 102) to carry over flows of the mutual funds 4 (received in step 106). In step 108B, the financial service provider 2 compares eligible carry over flows to new subscription flows for each of the funds 4. In step 108C, the financial service provider 2 compares eligible carry over flows to new redemption flows for each of the funds 4. In step 108D, the financial service provider 2 compares subscription flows to redemption flows and performs flow allocations in step 108E.

It can be appreciated that a number of different, reasonable combinations of amounts of purchases of different kinds of cash assets 30, futures 36 and other investments 40 are possible and can be performed by the financial service provider 2 in the practice of the present methods and systems. In one aspect, the use of futures 36, for example, in the pool of assets and liabilities 28 permits increased opportunities for flow allocation by the financial service provider 2 to address the flow allocation needs of the participating mutual funds 4.

It can be appreciated that a combination of mutual fund shares 34 and futures 36, for example, permits the financial service provider 2 to increase its capacity to allocate flows among the participating mutual funds 4 with enhanced magnitude and frequency. In addition, a certain amount of risk capital may be employed by the financial service provider 2 to mitigate risks associated with mismatched asset conditions within the pool of assets and liabilities 28. In another example embodiment of the present methods and systems, the full amount of the cash assets 30 can be invested in shares 34 of the participating mutual funds 4 with no amount of futures 36 being purchased.

In step 110, the results of the flow allocations, as well as flow allocation opportunities, for example, can be posted by the financial service provider 2. The results of the flow allocations can be posted in step 110 by any wireline or wireless communication system and/or method known to those skilled in the art such as by telephone, facsimile, electronic mail, Internet site, pager, and the like.

In step 112, the financial service provider 2 executes mutual fund orders based on the flow allocation activity of the trading day. Any non-addressed flow needs can be channeled to carry over flow status in step 106 for processing during a trading period subsequent to the current trading period. Flow allocation activities can then resume at step 104 with another calculation of eligible flows for each of the funds 4 based on the carry over flows and new flow allocation needs received from the funds 4 in step 102.

It can be appreciated that the method embodiments described in FIGS. 2 through 4 can be performed iteratively over a number of trading days to substantially continuously address the flow allocation needs of the participating mutual funds 4. In connection with needs for receiving flow services from the financial service provider 2, it can be appreciated that each of the participating mutual funds 4 may perform one or more internal procedures at the close of the business day to determine a net inflow or outflow for the mutual fund 4 for that day. Each of the participating mutual funds 4 can then communicate that net inflow or outflow calculation to the financial service provider 2 to identify eligible flows that may be addressed by the financial service provider 2.

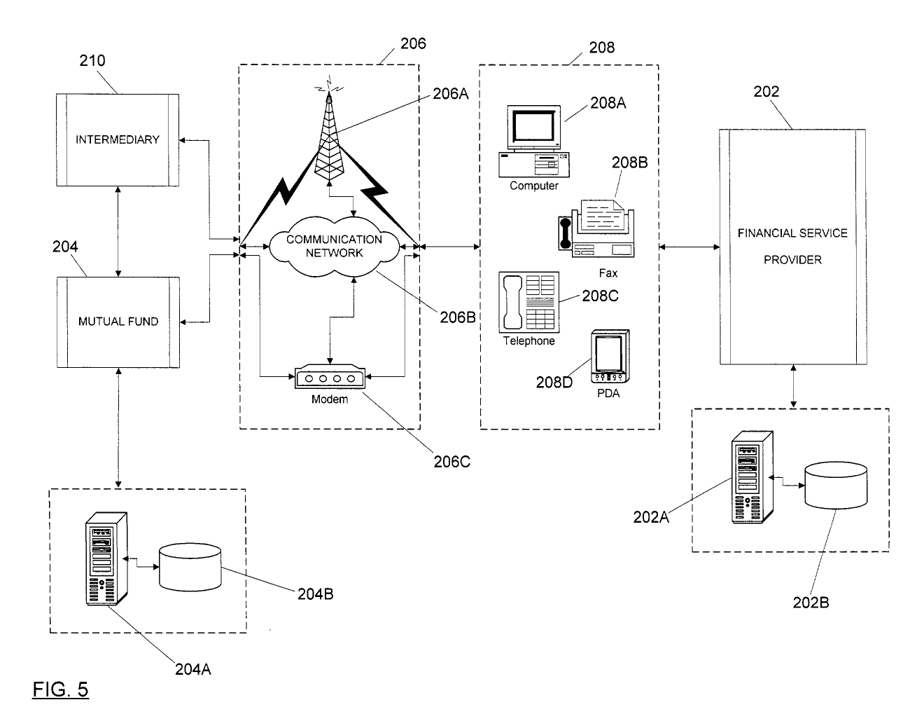

Referring now to FIG. 5, one example system embodiment provided in accordance with the present methods and systems is illustrated. As shown, a financial service provider 202 can communicate with a mutual fund 204 through a communication interface 206 using one or more communication devices 208. It can be appreciated that the mutual fund 204 and/or the financial service provider 202 can be replaced by one or more other types of investment pools, collective investment pools, or other entities in accordance with the various method embodiments discussed herein (the mutual fund 204 and the financial service provider 202 are shown merely for convenience of disclosure). The communication interface 206 can include, for example, a wireless connection 206A, a connection through a communication network 206B such as the Internet or an intranet, and/or a wireline connection such as through a modem 206C. It can be seen that one or more of these communication interfaces 206 may be employed alone or in reasonable combination to permit communication between the mutual fund 204 and the financial service provider 202. The communication devices 208 can include, for example and without limitation, a computer 208A, fax machine 208B, a telephone connection 208C (e.g., wireless, over a public switched telephone network, through a satellite connection, and the like), and/or a personal digital assistant 208D or a pager. It can be appreciated that any communication device 208 suitable for effecting communication between the financial service provider 202 and the mutual fund 204 can be employed within the scope of the present methods and systems. In addition, one or more such communication devices 208 may be employed alone or in reasonable combination to effect communication between the financial service provider 202 and the mutual fund 204.

The mutual fund 204 can be operatively associated with one or more servers, such as server 204A, for example, and one or more databases, such as database 204B, for example. The server 204A and the database 204B of the mutual fund 204 can be operatively configured to store and process data related to the investments, assets, and other financial data of the mutual fund 204. In addition, the financial service provider 202 can be operatively associated with one or more servers, such as server 202A, for example, and one or more databases, such as database 202B, for example. The server 202A and the database 202B of the financial service provider 202 can be operatively configured to store and process data related to the investments, assets, and other financial data of financial service provider 202 and of the mutual fund 204. It can be appreciated that the server 202A and the database 202B of the financial service provider 202 can also be configured to assist the financial service provider 202 in servicing the inflow and outflow needs of the mutual fund 204, such as by the various methods described hereinabove.

In addition, an intermediary 210 may be employed by the mutual fund 204 to process communications between the mutual fund 204 and the financial service provider 202. Examples of the intermediary 210 include, without limitation, transfer agents, custodians, global custodians, and other like entities capable of conveying financial information from the mutual fund 204 to the financial service provider 202 through the communication interface 206. The intermediary 210 may be utilized, for example, to collect subscription/redemption orders, generate summary reports, transmit net subscription and/or net redemption data, and to perform other financial functions for the mutual fund 204. It can be seen that the mutual fund 204 may desire to interact with the financial service provider 202 through the communication interface 206 with or without a degree of assistance from the intermediary 210.

In one aspect of the present methods and systems, the securities 6 are sold to the participating mutual funds 4 by the financial service provider 2 to facilitate redemptions, subscriptions, and associated flow allocation activity. In one aspect, no implied or express contractual obligation exists for the financial service provider 2 to purchase or redeem any predetermined amount of shares of the participating mutual funds 4. The financial service provider 2 thus retains control of investment decisions with respect to the shares it has purchased from the participating mutual funds 4. Likewise, each of the participating mutual funds 4 retains the authority to participate in the services provided by the financial service provider 2 by purchasing one or more securities 6 from the financial service provider 2, or not to participate in the services offered by the financial service provider 2 by liquidation of the security 6 purchased from the financial service provider 2, for example.

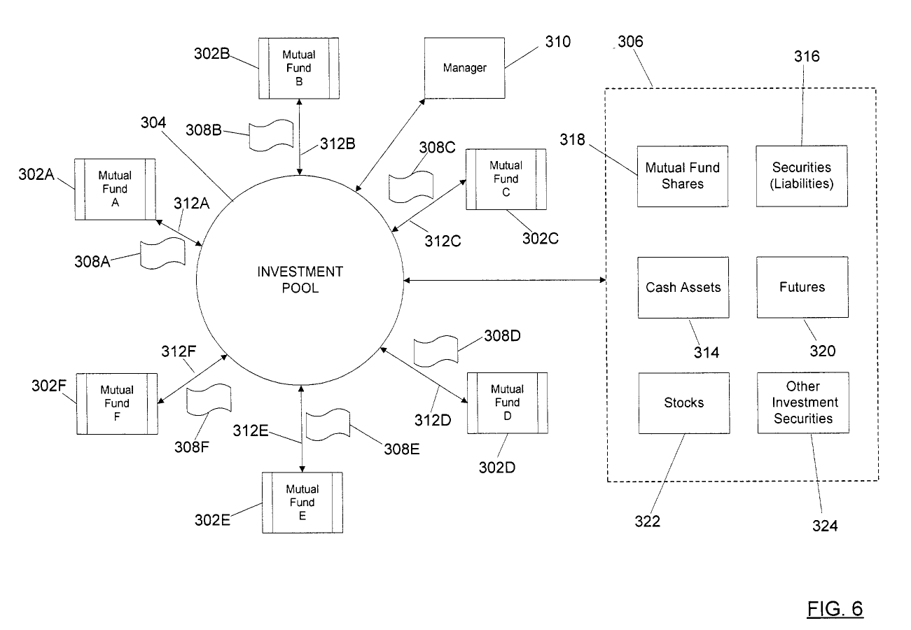

Referring now to FIG. 6, in another embodiment of the present methods and systems, a method for allocating flows between/among mutual funds can be provided. As shown, participating mutual funds 302A-302F can collaborate to form a collective investment pool 304 that is operatively associated with at least one pool of assets and liabilities 306. For convenience of disclosure, and where appropriate and applicable, the mutual funds 302A-302F may be referred to as mutual funds 302, collectively, or as mutual fund 302 for a single fund. It can be seen that the mutual funds 302 can perform various transactions with the investment pool 304 that involve the sale of assets and the purchase of securities 308A-308F. For convenience of disclosure, and where appropriate and applicable, the securities 308A-308F may be referred to as securities 308, collectively, or as a single security 308. In one aspect, the mutual funds 302 may engage a manager 310 to facilitate, monitor, and/or process transactions between/among the mutual funds 302 and the investment pool 304.

As shown in FIG. 6, the investment pool 304 can sell the securities 308A-308F, respectively, to the participating mutual funds 302A-302F through an operative association to the investment pool 304 (wherein the operative association between the mutual funds 302 and the investment pool 304 can be represented by the links 312A-312F, respectively, with the mutual funds 302A-302F). The sale of the securities 308A-308F to the mutual funds 302A-302F occurs in exchange for payment of a portion of the assets of the mutual funds 304A-304F through the links 312A-312F (respectively).

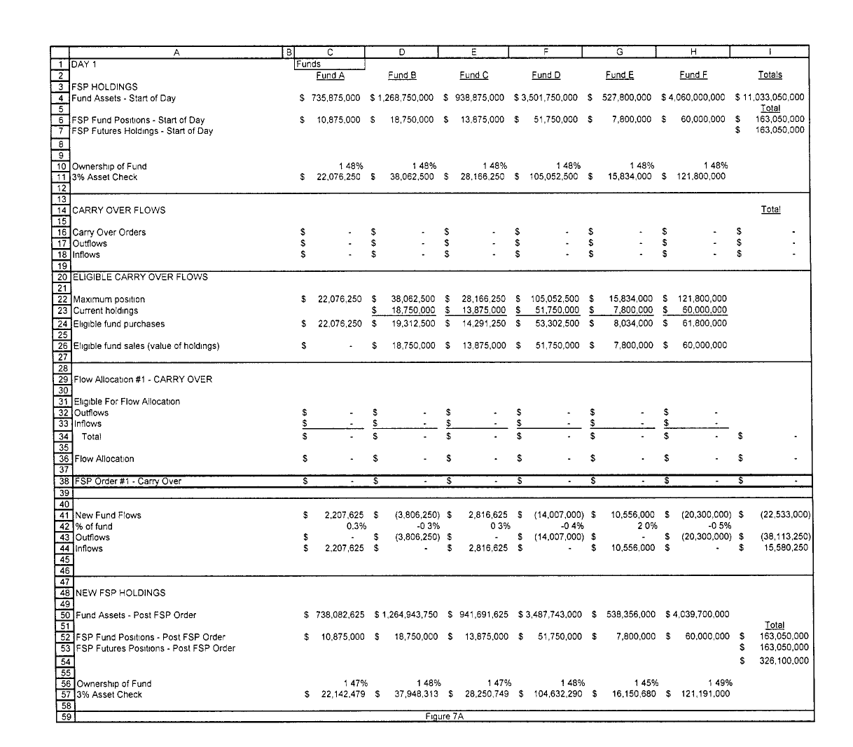

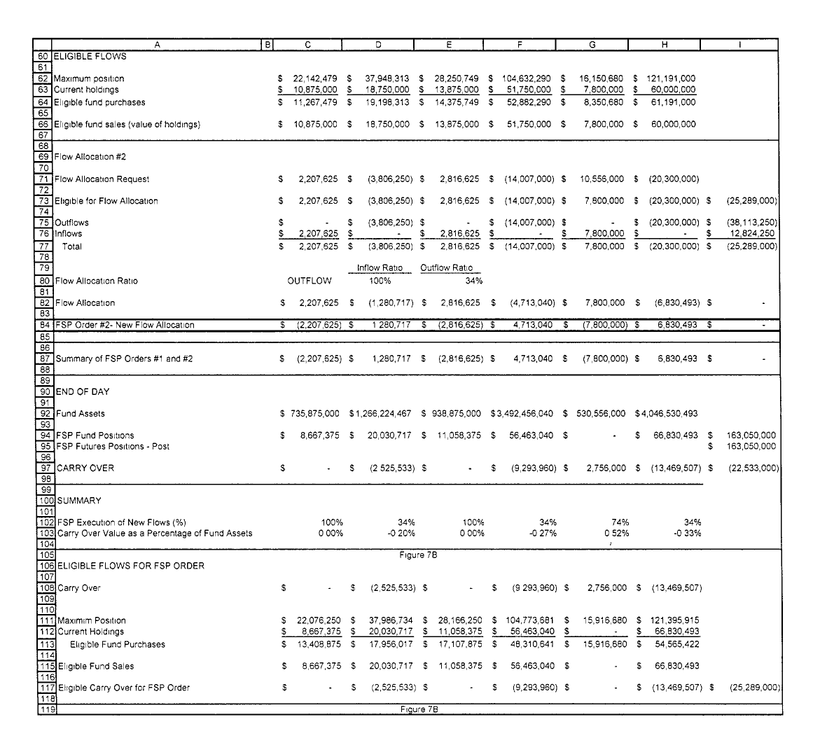

In one aspect of the present methods and systems, the investment pool 304 sells one of the securities 308 in exchange for payment of a percentage of the value of assets of one of the mutual funds 302 up to 10%, for example, of the total value of the assets of the purchasing mutual fund 302. In one illustrative embodiment, one of the securities 308 can be sold in exchange for payment of 3%, for example, of the value of the assets of the purchasing mutual fund 302. In another aspect of the present methods and systems, each of the securities 308 possesses a variable rate of return related to the rate of return of the investment pool 304. In another aspect, the rate of return of the security 308 may be substantially equal to the rate of return of the investment pool 304. In another aspect, the rate of return of the security 308 may be a percentage of the rate of return of the investment pool 304. In another aspect, the security 6 may maintain a conventional rate of return that is not related to the rate of return of the mutual fund 4 or an activity/entity employed by the mutual funds 4. While only mutual funds 302A-302F are shown in FIG. 7 for convenience of illustration, it can be appreciated that any number of mutual funds can participate to form the collective investment pool 304.

In another aspect of the present methods and systems, the pool of assets and liabilities 306 can include, for example and without limitation, cash assets 314 derived from the sale of securities 316 (accounted as liabilities) and/or shares 318 of the various participating mutual funds 302 to which securities 308 have been sold. The pool of assets and liabilities 306 can be used by the investment pool 304 to purchase and/or redeem shares of the mutual funds 304 to which securities 308 have been sold and/or to make other investments pursuant to an investment strategy of the investment pool 304. In one embodiment, the pool of assets and liabilities 306 may also include an amount of futures 320 to enhance the ability of the investment pool 304 to address the flow allocation needs of the participating mutual funds 302. In other aspects, the pool of assets and liabilities 306 may also include an amount of stocks 322 and/or other investment securities 324.

In operation during a given trading period, each participating mutual fund 302 experiences an inflow of cash assets received from investors purchasing shares of the participating mutual fund 302 and/or an outflow of cash assets caused by investors redeeming shares in the mutual fund 302. The investment pool 304 can employ the sale of securities 308 and its pool of assets and liabilities 306 to reduce or eliminate the variations in outflows and inflows occasioned by this subscription and redemption activity of investors and shareholders of the participating mutual funds 302. In analogous accordance with various embodiments of the present methods and systems (discussed hereinabove), the investment pool 304 and the pool of assets and liabilities 306 can be employed by the manager 310 to purchase or redeem shares from the participating mutual funds 302. This purchase/redemption activity can be used to offset flows experienced by the mutual funds 302 during a given trading period.

In another embodiment of the present methods and systems, the investment pool 304, the pool of assets and liabilities 306, and/or the manager 310 can be configured in accordance with the operation of a closed-end mutual fund. In this embodiment, the number of participating mutual funds 302 that can perform (or are permitted to perform) transactions with the investment pool 304 of the closed-end mutual fund may be limited. In another aspect, the investment pool 304 and/or the pool of assets and liabilities 306 can be configured as a private equity pool.

### OPERATIONAL EXAMPLE

The following example includes six mutual funds in operative association with the financial service provider 2 in connection with various aspects of the present methods and systems described hereinabove. This example is intended merely for illustration of various aspects of the present methods and systems for those skilled in the art. As applied herein, spreadsheet line numbers are employed in FIGS. 7A through 10 for convenience of disclosure of various aspects of the present methods and systems. As sometimes used herein, the term “FSP” is applied as an abbreviation for the “financial service provider” entity.

Referring now to FIGS. 7A and 7B, the first day (i.e., “Day 1”) of a market trading period of a multiple number of days is presented in spreadsheet format. As shown at line 2, a plurality of mutual funds (i.e., Funds A, B, C, D, E and F) engage the services of the financial service provider and each fund possesses the respective fund assets shown at line 4 at the start of the trading day.

As described previously hereinabove, each fund sells a percentage of its assets to the FSP in exchange for a security that pays a rate of return associated with the rate of return of the fund. In the present example, the FSP uses a portion (e.g., 50%) of the proceeds from the sale of securities to the funds to purchase shares of the funds. In addition, as described hereinabove, to enhance the capacity of the FSP to address the flow needs of the funds, the FSP can use the balance of the proceeds from the sale of the securities to purchase futures, for example, or another suitable investment security. The dollar amounts shown at line 6 show that 50% of the proceeds received by the FSP from sales of securities to the funds have been employed by the FSP to purchase shares of the funds.

At line 10, a calculation can be performed to determine what percentage of the total assets of each of the funds that the FSP owns. At line 11, a calculation can be performed to determine what dollar amount is associated with a predetermined percentage of the total assets of each fund. For example, at line 11, a calculation is performed to determine what dollar amount is 3% of the total assets of a particular fund. In various aspects of the methods and systems, the value calculated at line 11 can provide a maximum dollar amount of shares of a given fund that the FSP is permitted to hold.

Lines 20-39 illustrate how the FSP determines the order it will place to the funds based on carry over flows. At lines 16-18, carry over flows from a previous trading period are shown. FIGS. 7A and 7B show the first day of the trading period in this example, however, so it can be appreciated that the fields at lines 16-18, and various other fields discussed hereinafter, are blank for Day 1.

At line 22, a maximum position can be calculated for each fund by multiplying the amount shown at line 4 by a predetermined percentage (e.g., 3%). This is the maximum dollar amount of shares or position of the fund that the FSP can maintain after the FSP places an order based on the carry over flows. By subtracting the current holdings of FSP in each fund (see line 23) from the maximum position (line 22), an amount for eligible fund purchases (i.e., subscriptions) can be calculated at line 24. An eligible fund sales amount, which is equal to the current holdings value (line 23), can also be provided at line 26.

Lines 29-38 illustrate how FSP calculates the order it will place against carry over order flows. The FSP checks the carry over flow amounts in connection with the previously determined eligibility information (lines 22-26) to determine the eligible carry over order that the FSP can address based on its position in each fund. The dollar amount of the carry over order is then designated, as appropriate, as an outflow (line 32) or an inflow (line 33). At line 36 (column 1) the net total flow of the carry over order can be calculated for the funds. The total eligible inflows and outflows are then summarized in line 36. Line 38 shows the actual carry over order placed by FSP, a negative number designating a fund sale and a positive number designating a fund purchase.

In one aspect of this operational example, it can be decided that all eligible carry over flow allocation needs are prioritized for processing by the FSP prior to processing other flow allocation needs communicated to the FSP for the trading day. At lines 31-34, carry over outflows and inflows that are to be processed by the FSP are shown. At line 36, the amount of the carry over flow for each fund that is processed by the FSP is calculated and shown. In one aspect, the amount in line 38 can be calculated based on a fixed, predetermined percentage of the amount of the outflow (line 32) or inflow (line 33), or can be calculated based on a formula that factors one or more amounts obtained from a prior trading day.

At line 41, each of the funds experiences a new fund flow for Day 1. An outflow (shown as a negative number in line 43) represents a net redemption result experienced by the fund for the day. An inflow (shown as a positive number in line 44) represents a net subscription result experienced by the fund for the day. At line 42, the percentage of the total assets of the fund (dollar amount shown at line 4 plus the carry over order in line 38) represented by the various inflows or outflows shown at lines 43 and 44 can be calculated for each fund. The FSP then calculates fund assets at line 50 by adding the carry over order to the assets in line 4. In line 52, the FSP calculates its updated holdings in the fund by adding the carry over order in line 38 to the FSP fund position in line 6. In line 56, the FSP calculates its percentage ownership position in each fund by dividing its holdings (line 52) by the fund assets (line 50).

The FSP calculates updated eligible fund order amounts at lines 64 and 66 that the FSP can address based on its position in each fund. At line 62, a maximum position can be calculated for each fund by adding the amount at line 4 to the amount shown at line 38 and multiplying the sum of these two amounts by a predetermined percentage (e.g., 3%). This is the maximum dollar amount of shares or position of the fund that the FSP can maintain. By subtracting the current holdings of FSP in each fund (see line 63) from the maximum position (line 62), an amount for eligible fund purchases (i.e., subscriptions) can be calculated at line 64. An eligible fund sales amount, which is equal to the current holdings value (line 63), can also be provided at line 66.

In line 71, the FSP calculates the allocation need by adding the current day fund flows in line 44 to the remaining carry over flows that are not fulfilled in the carry over order designated in line 38. The FSP checks the allocation need amount in connection with the previously determined eligibility information (lines 62-66) and calculates an eligible order amount in line 73. The dollar amount of line 73 is then designated, as appropriate, as an outflow (line 75) or an inflow (line 76). At line 77 (column I), the net total of all inflow and outflow needs can be calculated for the funds.

At line 80, a flow allocation ratio can be calculated for use in determining what portions of the flow allocation needs are to be processed by the FSP. In this example, because the total of all flow allocation needs at line 77 (column I) reflects a net outflow (i.e., a negative dollar amount), the ratio to be applied to inflows is calculated to be 100%, and the ratio to be applied to outflows is the total inflow amount (column I, line 76) divided by the total outflow amount (column I, line 75). It can be appreciated, however, in various aspects of the present methods and systems, that other formulae could be applied to determine the flow allocation ratio. In one aspect, the flow allocation ratio can be limited to a fixed, predetermined value based on the total assets of each fund (e.g., the flow allocation ratio could be fixed at 1% of the total assets for each fund).

At line 82, application of the flow allocation ratio to the dollar amount of line 77 results in the dollar amount of each flow allocation need that is to be processed by the FSP for the funds. At line 84, the order placed by the FSP based on the processed flow allocation need is shown. It can be seen that subscription orders are shown at line 84 as positive dollar amounts (e.g., cash spent on fund purchases), and redemption orders are shown at line 84 as negative dollar amounts (e.g., cash proceeds from fund sales). In line 87, the FSP provides a summary of the total order for the day by adding the carry over order in line 38 to the order in line 84.

At line 92, the fund assets resulting from Day 1 activities are displayed (i.e., the dollar amount at line 92 is the sum of the dollar amounts shown at lines 4, 41 and 87). At line 94, the dollar amount position of the FSP in each fund is shown as a consequence of trading activities. In addition, at line 97, carry over amounts are shown based on how the FSP addressed and processed the flow allocation needs of the funds (i.e., the carry over amount is calculated as the sum of the amounts shown in lines 16, 41 and 87).

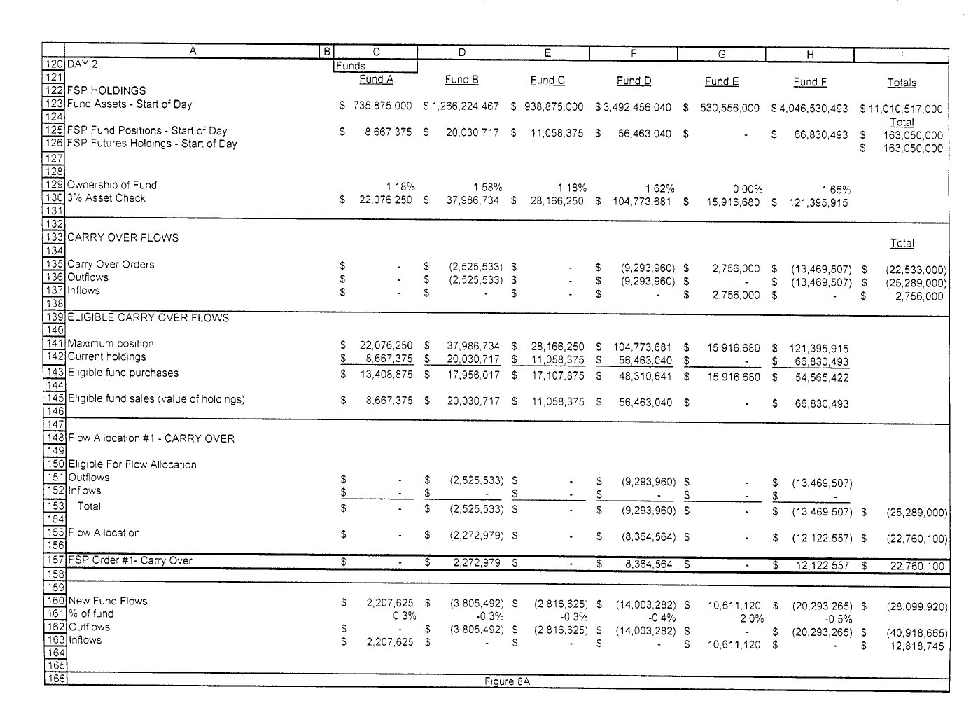

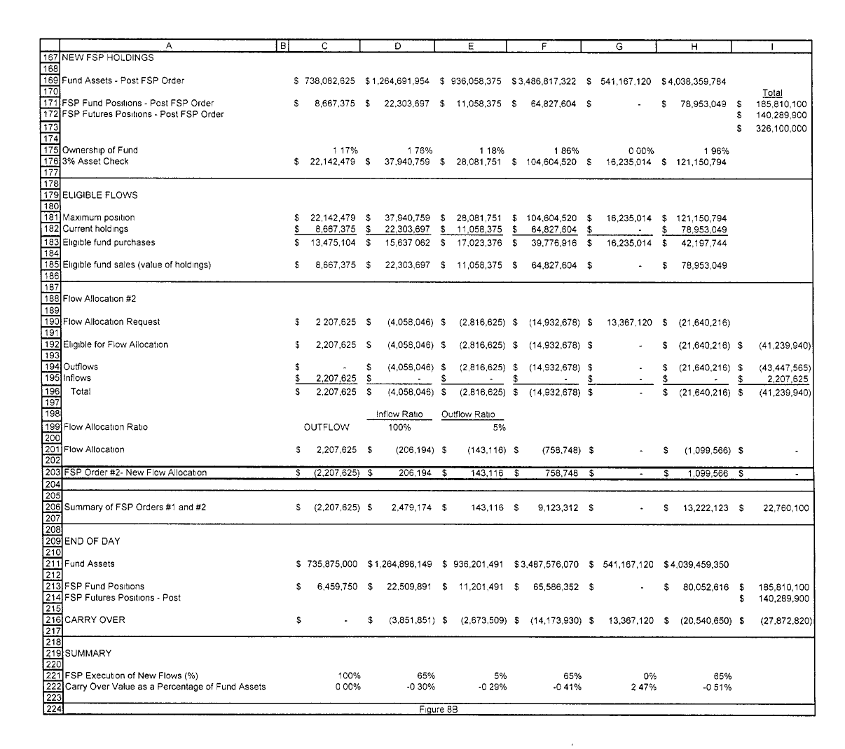

Referring now to FIGS. 8A and 8B, the second day (i.e., “Day 2”) of a trading period of a multiple number of days is presented in spreadsheet format. As shown at line 123, the funds (i.e., Funds A, B, C, D, E and F) each possess the respective fund asset dollar amounts at the start of the trading day. In this example, the dollar amounts shown at line 123 are the same as their respective amounts shown at line 92 of the Day 1 spreadsheet. In addition, the dollar amount position held by the FSP in each fund at the start of Day 2 is shown at line 125 (these amounts have been transferred from line 94 of the Day 1 spreadsheet).

At line 129, a calculation can be performed to determine what percentage of the total assets of each of the funds that the FSP owns. At line 130, a calculation can be performed to determine what dollar amount is associated with a predetermined percentage of the total assets of each fund. For example, at line 130, a calculation is performed to determine what dollar amount is 3% of the total assets of a particular fund. In various aspects of the methods and systems, the value calculated at line 130 can provide a maximum dollar amount of shares of a given fund that the FSP is permitted to hold.

Lines 139-158 illustrate how the FSP determines the order it will place to the mutual funds based on the carry over flows. At lines 135-137, carry over flows from a previous trading period are shown.

At line 141, a maximum position can be calculated for each fund by multiplying the amount at line 123 by a predetermined percentage (e.g., 3%). This is the maximum dollar amount of shares or position of the fund that the FSP can maintain after it places an order based on the carry over flows. By subtracting the current holdings of FSP in each fund (see line 125) from the maximum position (line 141), an amount for eligible fund purchases (i.e., subscriptions) can be calculated at line 143. An eligible fund sales amount, which is equal to the current holdings value (line 142), can also be provided at line 145.

Lines 148-157 illustrate how FSP calculates the order it will place against carry over order flows. The FSP checks the carry over flow amounts in connection with the previously determined eligibility information (lines 141-145) to determine the eligible carry over order that the FSP can address based on its position in each fund. The dollar amount of the carry over order is then designated as appropriate, as an outflow (line 151) or an inflow (line 152). At line 153 (column I) the net total flow of the carry over order can be calculated for the funds. The total eligible inflows and outflows for each fund are also summarized in line 153. In line 155, the FSP calculates the order it will make. Line 157 shows the actual carry over order placed by the FSP, a negative number designating a fund sale and a positive number designating a fund purchase.

In one aspect of this operational example, it can be decided that all eligible carry over flow allocation needs are prioritized for processing by the FSP prior to processing other flow allocation needs communicated to the FSP for the trading day. In one aspect, the amount in line 157 can be calculated based on a fixed, predetermined percentage of the amount of the outflow (line 151) or inflow (line 152), for example, or can be calculated based on a formula that factors one or more amounts obtained from a prior trading day.

At line 160, each of the funds experiences a new fund flow for Day 1. An outflow (shown as a negative number in line 162) represents a net redemption result experienced by the fund for the day. An inflow (shown as a positive number in line 163) represents a net subscription result experienced by the fund for the day. At line 175, the percentage of the total assets of the fund (dollar amount shown at line 169) represented by the various inflows or outflows shown at line 171 can be calculated for each fund. The FSP calculates fund assets by adding the carry over order to the assets in line 123. In line 171, the FSP calculates its updated holdings in the fund by adding the carry over order in line 155 to the FSP fund position in line 125. In line 175, the FSP calculates its position in each fund by dividing its holdings (line 171) by the fund assets (line 169). The FSP calculates updated eligible fund order amounts at lines 183 and 185 that the FSP can address based on its position in each fund.

At line 181, a maximum position can be calculated for each fund by multiplying the fund assets at line 169 by a predetermined percentage (e.g., 3%). This is the maximum dollar amount of shares or position of the fund that the FSP can maintain. By subtracting the current holdings of FSP in each fund (see line 171) from the maximum position (line 181), an amount for eligible fund purchases (i.e., subscriptions) can be calculated at line 183. An eligible fund sales amount, which is equal to the current holdings value (line 182), can also be provided at line 185.

In line 190, the FSP calculates the flow allocation request by adding the current day fund flows in line 160 to the remaining carry over flows that are not fulfilled in the carry over order designated in line 135. The FSP checks the flow allocation request amount in connection with the previously determined eligibility information (lines 181-185) and calculates an eligible order amount in line 192. The dollar amount of line 192 is then designated, as appropriate, as an outflow (line 194) or an inflow (line 195). At line 196 (column I), the net total of all inflow and outflow needs can be calculated for the funds.

At line 199, a flow allocation ratio can be calculated for use in determining what portions of the flow allocation needs are to be processed by the FSP. In this example, because the total of all flow allocation needs at line 196 (column I) reflects a net outflow (i.e., a negative dollar amount), the ratio to be applied to inflows is calculated to be 100%, and the ratio to be applied to outflows is the total inflow amount (column I, line 195) divided by the total outflow amount (column I, line 194). It can be appreciated, however, in various aspects of the present methods and systems, that other formulae could be applied to determine the flow allocation ratio. In one aspect, the flow allocation ratio can be limited to a fixed, predetermined value based on the total assets of each fund (e.g., the flow allocation ratio could be fixed at 1% of the total assets for each fund).

At line 201, application of the flow allocation ratio to the dollar amount of line 196 results in the dollar amount of each flow allocation need that is to be processed by the FSP for the funds. At line 203, the order placed by the FSP based on the processed flow allocation need is shown. It can be seen that subscription orders are shown at line 203 as positive dollar amounts (e.g., cash spent on fund purchases), and redemption orders are shown at line 203 as negative dollar amounts (e.g., cash proceeds from fund sales). In line 206, the FSP provides a summary of the day's total order by adding the carry over order in line 157 to the order in line 203.

At line 211, the fund assets resulting from Day 2 activities are displayed (i.e., the dollar amount at line 211 is the sum of the dollar amounts shown at lines 123, 160 and 206). At line 213, the dollar amount position of the FSP in each fund is shown as a consequence of trading activities. In addition, at line 216, carry over amounts are shown based on how the FSP addressed and processed the flow allocation needs of the funds (i.e., the carry over amount is calculated as the sum of the amounts shown in lines 135, 160, and 206).

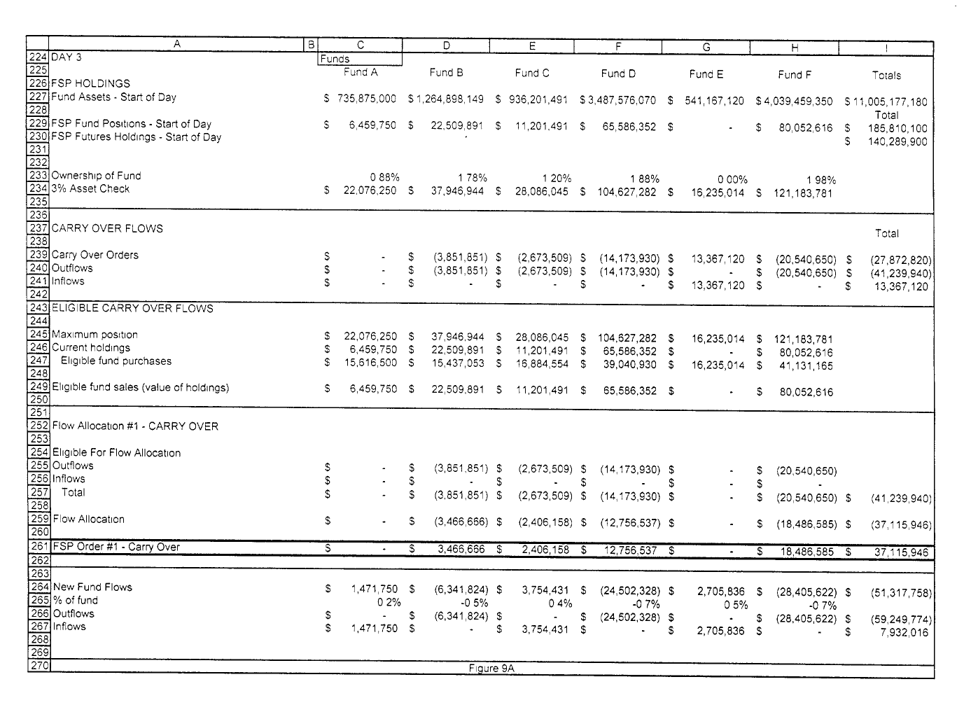

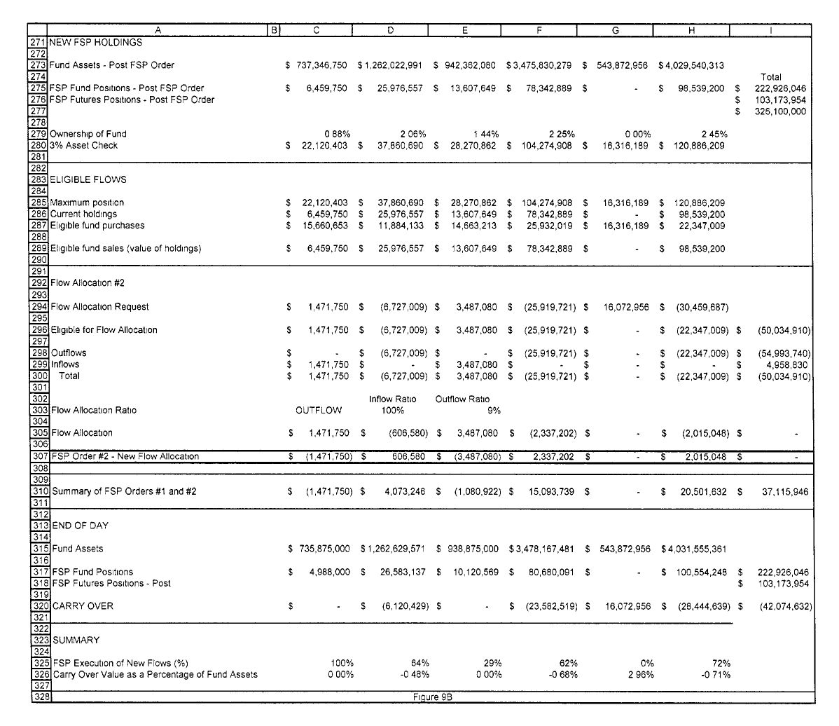

Referring now to FIGS. 9A and 9B, the third day (i.e., “Day 3”) of a market trading period of a multiple number of days is presented in spreadsheet format. For convenience of disclosure, it can be appreciated that the various operational aspects of Day 3 activities are substantially similar to those of Day 2 activities. The flow allocation activities of Day 3 are analogous and iterative with respect to activities performed on prior trading days of this operational example. It can be further appreciated that the iterative flow allocation methods can proceed for any suitable number of days in accordance with practice of the present methods and systems.

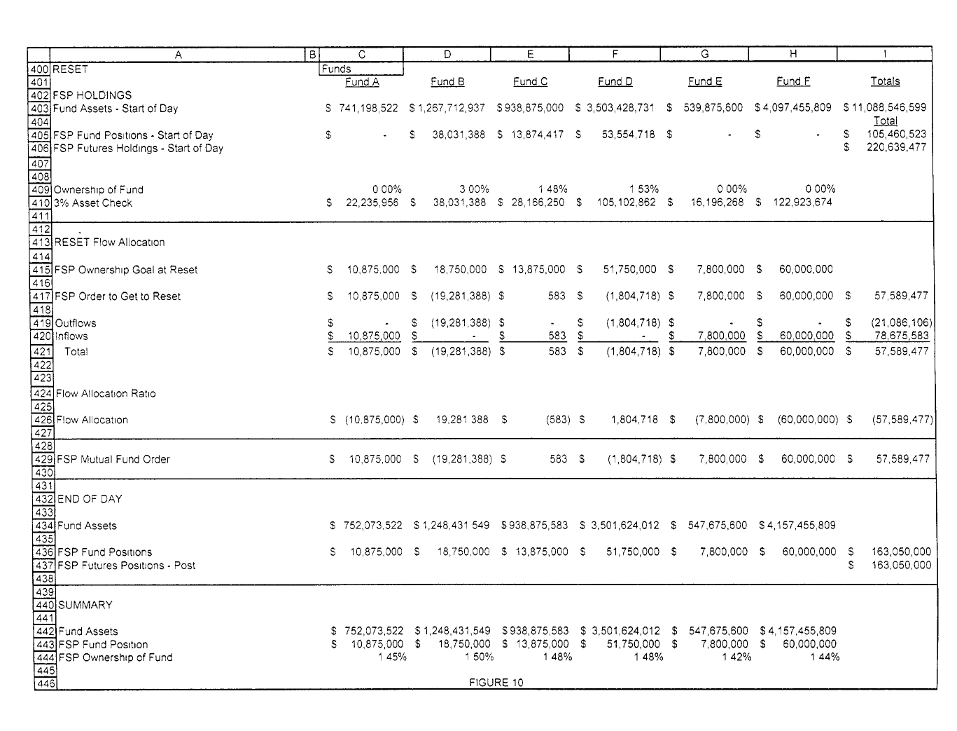

Referring now to FIG. 10, in another aspect, assuming that a period of twenty trading days has occurred involving flow allocation activities performed by the FSP for the various funds, a reset or rebalance can be performed by the FSP.

At line 403, the total amount of assets of each fund at the end of the twenty-day period is shown. At line 405, the amount of assets of each fund held by the FSP is shown. At line 409, a calculation can be performed to determine what percentage of the assets of each fund is currently held by the FSP (i.e., what percentage of the amount at line 403 is represented by the amount at line 405). In addition, at line 410, a check can be performed to determine what dollar amount is a predetermined percentage amount (e.g., 3%) of the total assets of each fund (line 403). In one aspect, the amount calculated at line 410 can be used as a maximum dollar amount of assets that can be held by the FSP for a given fund.

At line 415, an ownership goal can be established for the amount of assets of each fund that the FSP should hold. In the present example, the goal amount shown at line 415 is equal to 50% of the value of the amount of assets initially received from each fund (see line 6, Day 1) as proceeds from the sale of a security to each fund.

At line 417, a calculation can be performed to determine what order must be placed to achieve the goal amount of line 415 for the FSP. It can be seen that the amount at line 417 is determined for each fund by subtracting the amount shown at line 405 from the goal amount at line 415. The order amount calculated at line 417 can be categorized as either an outflow (at line 419) or an inflow (at line 420). At line 421, the sum of lines 419 and 420 can be calculated and shown.

At line 426, the flow allocation for each fund can be designated as the negative of the value shown at line 421. At line 429, to perform the reset, the FSP can place an order for each fund (a subscription order or a redemption order, as appropriate) equal to the negative of the value shown at line 426.

After the reset is performed, at line 434 the total assets for each fund can be calculated as the sum of the amounts shown at lines 403 and 429. At line 436, the position of each fund held by the FSP after the reset can be calculated as the sum of the amounts shown at lines 405 and 429. At line 444, the percentage of the total assets of each fund currently held by the FSP can be shown by calculating the position of each fund held by the FSP (line 436) as a percentage of the total assets of each fund (line 434).

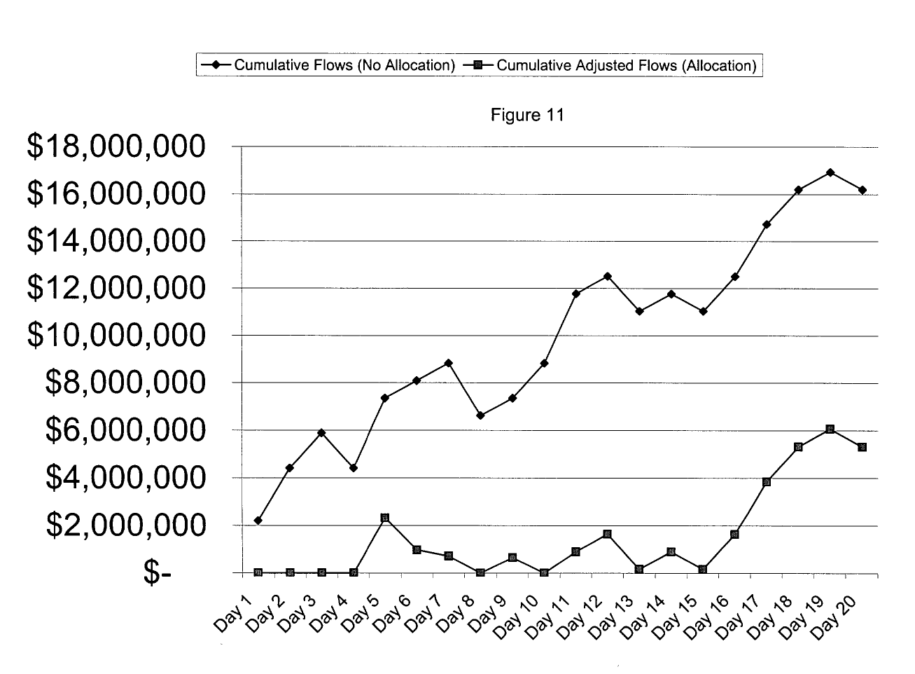

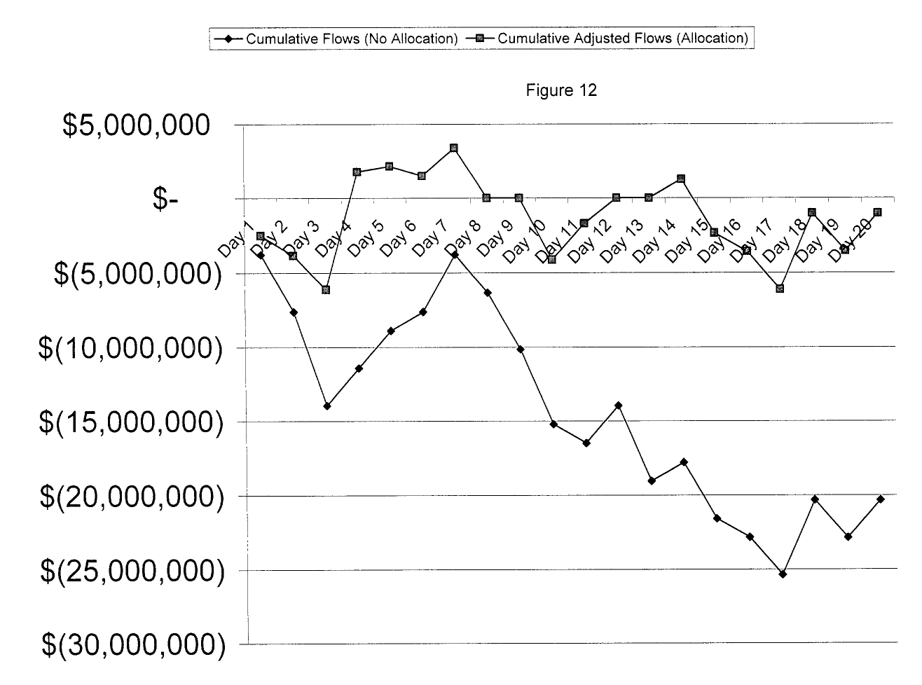

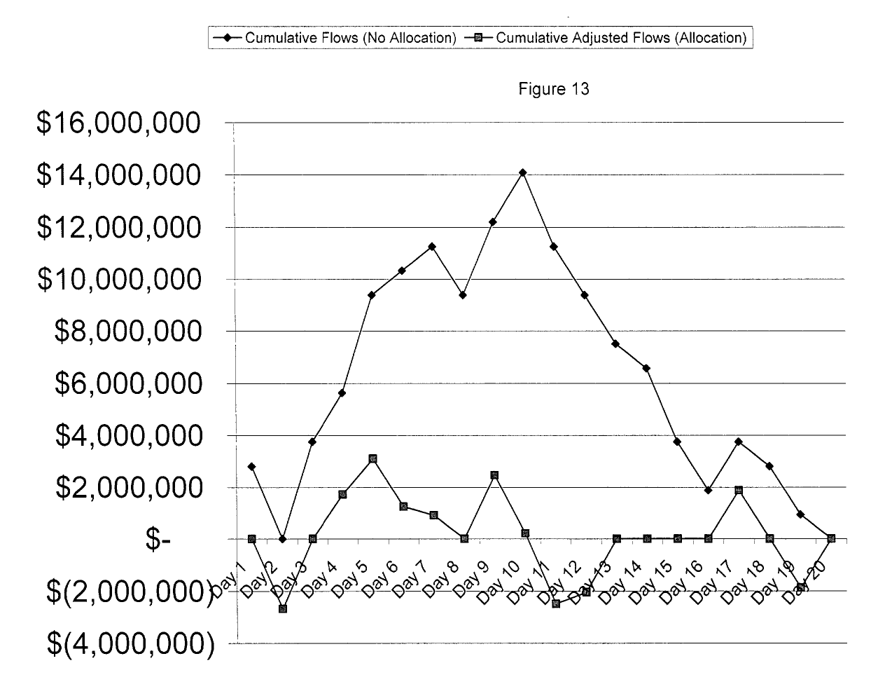

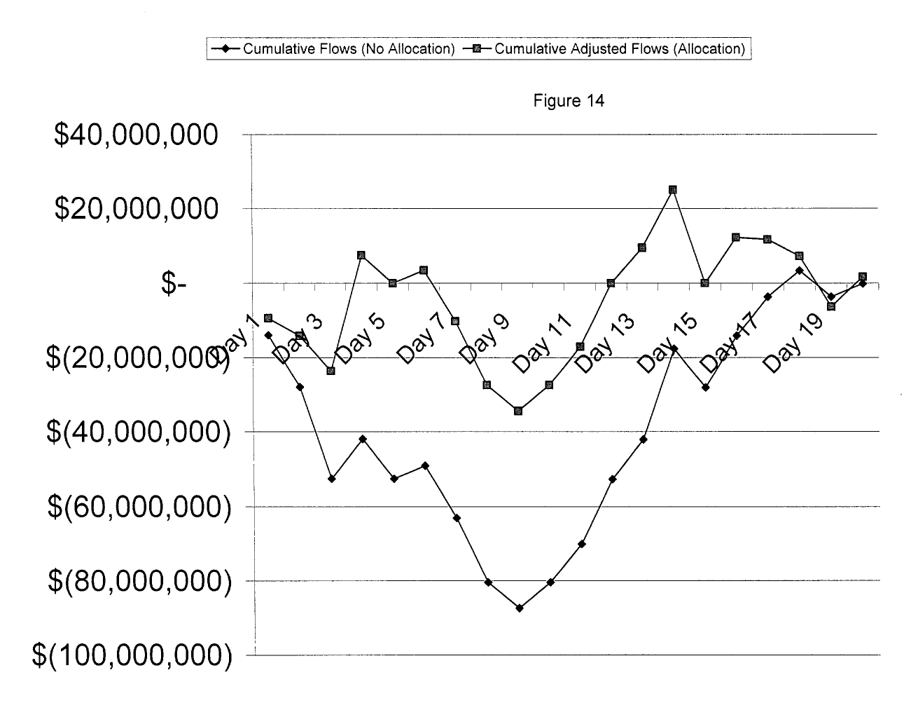

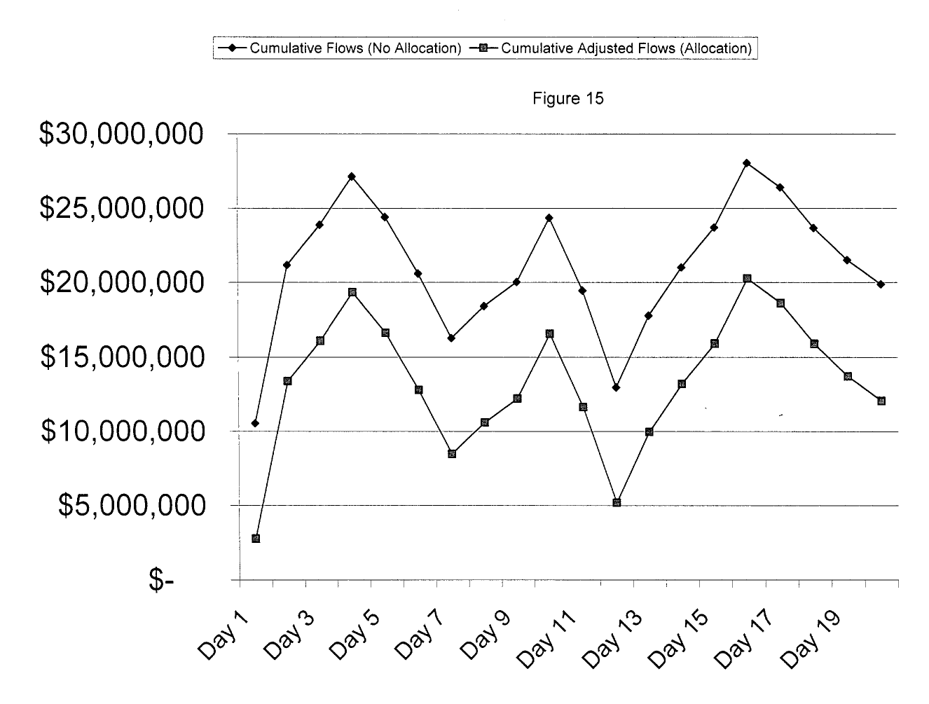

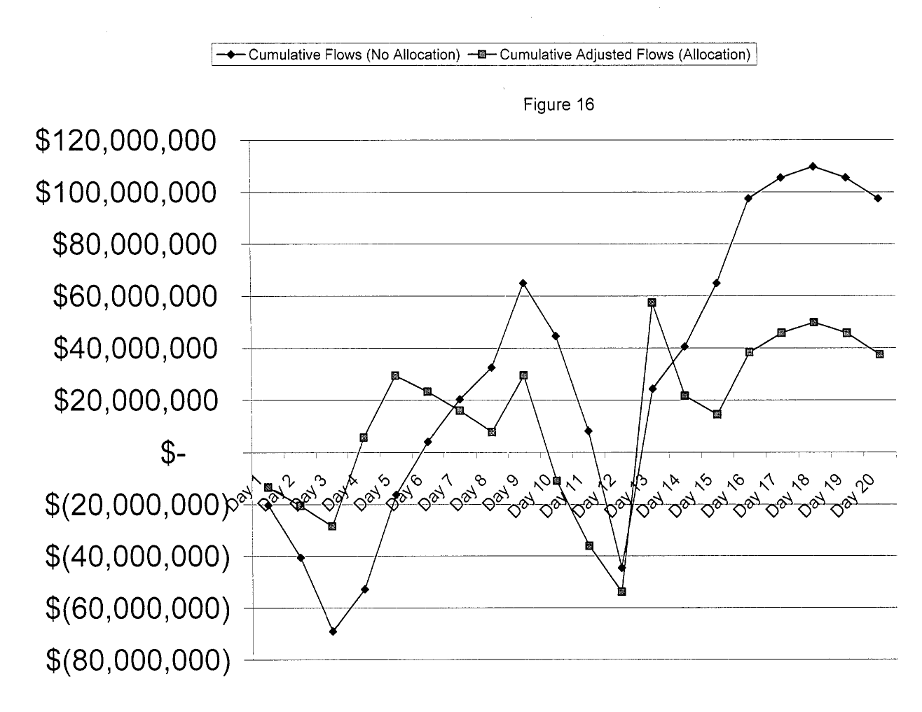

Referring now to FIGS. 11 through 16, graphical representations are provided that compare cumulative flows to cumulative adjusted flows for each of the funds A, B, C, D, E and F (respectively). The graphical representations assume a period of twenty days of operation of the present methods and systems, but do not include the reset event discussed with respect to FIG. 10 (discussed hereinabove). In accordance with the discussion hereinabove, FIGS. 11 through 16 demonstrate that the use of the present methods and systems will at least partially convert daily inflow and/or outflow events into events that can be addressed and managed on a comparatively longer-term basis (e.g., monthly, quarterly, semi-annually, or other suitable period).

The examples presented herein are intended to illustrate potential implementations of the present method and system embodiments. It can be appreciated that such examples are intended primarily for purposes of illustration. No particular aspect or aspects of the example method and system embodiments described herein are intended to limit the scope of the present invention. The configuration and specific functions of a particular flow allocation method, for example, are provided merely for convenience of disclosure.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein.

The terms “computer” and “computer system” as applied herein may include, without limitation, one or more of the following devices: a wireless personal computer, a laptop, a personal digital assistant (PDA), a wireless pager, a “computer” may be a microcomputer, minicomputer, laptop, personal data assistant, cellular phone, two-way pager, processor, and any other computerized device capable of transmitting, receiving and/or processing data over a shared network.

The term “computer-readable medium” is defined herein as understood by those skilled in the art. It can be appreciated that various method steps described herein may be performed, in certain embodiments, using instructions stored on a computer-readable medium or media that direct a computer system to perform the method steps. A computer-readable medium can include, for example, memory devices such as diskettes, compact discs of both read-only and writeable varieties, optical disk drives, and hard disk drives. A computer-readable medium can also include memory storage that can be physical, virtual, permanent, temporary, semi-permanent and/or semi-temporary. A computer-readable medium can further include one or more data signals transmitted on one or more carrier waves.

It can be appreciated that, in some embodiments of the present methods and systems disclosed herein, a single component can be replaced by multiple components, and multiple components replaced by a single component, to perform a given function. Except where such substitution would not be operative to practice the present methods and systems, such substitution is within the scope of the present invention.

Whereas particular embodiments of the invention have been described herein for the purpose of illustrating the invention and not for the purpose of limiting the same, it can be appreciated by those of ordinary skill in the art that numerous variations of the details, materials and arrangement of parts may be made within the principle and scope of the invention without departing from the invention as described in the appended claims.

What is claimed is:

1. A method for assisting at least one investment pool with managing flows of said investment pool, said method comprising:
selling a security to said investment pool;
receiving an amount of assets of said investment pool as payment for said security; and,
performing at least one of a subscription transaction and a redemption transaction for said investment pool using at least a portion of said payment.

2. The method of claim 1, further comprising forming a pool of assets and liabilities including at least a portion of said amount of said assets received from said investment pool.

3. The method of claim 2, further comprising selling a security to at least a second investment pool; receiving an amount of assets of said second investment pool as payment for said security; and, including said amount of said assets received from said second investment pool in said pool of assets and liabilities.

4. The method of claim 2, wherein said investment pool further includes at least a first mutual fund and a second mutual fund, wherein said assets of said investment pool include shares of said mutual funds, further comprising redeeming at least a portion of said shares of one of said mutual funds to perform a subscription transaction for the other of said mutual funds.

5. The method of claim 1, further comprising performing a reset for said investment pool in association with said amount of said assets of said investment pool.

6. A system for assisting at least one investment pool with managing flows of said investment pool, said system comprising:
means for selling a security to said investment pool;
means for receiving an amount of assets of said investment pool as payment for said security; and,
means for performing at least one of a subscription transaction and a redemption transaction for said investment pool using at least a portion of said payment.

7. The system of claim 6, further comprising means for forming a pool of assets and liabilities including at least a portion of said amount of said assets received from said investment pool.

8. The system of claim 7, further comprising means for selling a security to at least a second investment pool; means for receiving an amount of assets of said second investment pool as payment for said security; and, means for including said amount of said assets received from said second investment pool in said pool of assets and liabilities.

9. The system of claim 7, wherein said investment pool further includes at least a first mutual fund and a second mutual fund, wherein said assets of said investment pool include shares of said mutual funds, further comprising means for redeeming at least a portion of said shares of one of said mutual funds to perform a subscription transaction for the other of said mutual funds.

10. The system of claim 6, further comprising means for performing a reset for said investment pool in association with said amount of said assets of said investment pool.

11. A computer-readable medium including instructions for performing a method for assisting at least one investment pool with managing flows of said investment pool, said method comprising:
selling a security to said investment pool;
receiving an amount of assets of said investment pool as payment for said security; and,
performing at least one of a subscription transaction and a redemption transaction for said investment pool using at least a portion of said payment.

12. The medium of claim 11, further comprising instructions for forming a pool of assets and liabilities including at least a portion of said amount of said assets received from said investment pool.

13. The medium of claim 12, further comprising instructions for selling a security to at least a second investment pool; instructions for receiving an amount of assets of said second investment pool as payment for said security; and, instructions for including said amount of said assets received from said second investment pool in said pool of assets and liabilities.

14. The medium of claim 12, wherein said investment pool further includes at least a first mutual fund and a second mutual fund, wherein said assets of said investment pool include shares of said mutual funds, further comprising instructions for redeeming at least a portion of said shares of one of said mutual funds to perform a subscription transaction for the other of said mutual funds.

15. The medium of claim 11, further comprising instructions for performing a reset for said investment pool in association with said amount of said assets of said investment pool.

16. A method for assisting an investment pool with managing flows of said investment pool, said method comprising:
selling a security to said investment pool, wherein a rate of return of said security is equal to a percentage of a rate of return of said investment pool; and,
receiving an amount of assets of said investment pool as payment for said security.

17. The method of claim 16, further comprising performing a subscription transaction for said investment pool.

18. The method of claim 16, further comprising performing a redemption transaction for said investment pool.

19. The method of claim 16, further comprising placing at least a portion of said amount of said payment into a pool of assets and liabilities.

20. The method of claim 19, further comprising using said pool of assets and liabilities to perform at least one redemption transaction for said investment pool.

21. The method of claim 19, further comprising using said pool of assets and liabilities to perform at least one subscription transaction for said investment pool.

22. The method of claim 16, further comprising performing a reset for said investment pool in association with said amount of said assets received from said investment pool.

23. A system for assisting an investment pool with managing flows of said investment pool, said system comprising:
means for selling a security to said investment pool, wherein a rate of return of said security is equal to a percentage of a rate of return of said investment pool; and,
means for receiving an amount of assets of said investment pool as payment for said security.

24. The system of claim 23, further comprising means for performing a subscription transaction for said investment pool.

25. The system of claim 23, further comprising means for performing a redemption transaction for said investment pool.

26. The system of claim 23, further comprising means for placing at least a portion of said payment into a pool of assets and liabilities.

27. The system of claim 26, further comprising means for using said pool of assets and liabilities to perform at least one redemption transaction for said investment pool.

28. The system of claim 26, further comprising means for using said pool of assets and liabilities to perform at least one subscription transaction for said investment pool.

29. The system of claim 23, further comprising means for performing a reset for said investment pool in association with said payment received from said investment pool.

30. A computer-readable medium including instructions for performing a method for assisting an investment pool with managing flows of said investment pool, said method comprising:
selling a security to said investment pool, wherein a rate of return of said security is equal to a percentage of a rate of return of said investment pool; and,
receiving an amount of assets of said investment pool as payment for said security.

31. The medium of claim 30, further comprising instructions for performing a subscription transaction for said investment pool.

32. The medium of claim 30, further comprising instructions for performing a redemption transaction for said investment pool.

33. The medium of claim 30, further comprising instructions for placing at least a portion of said payment into a pool of assets and liabilities.

34. The medium of claim 33, further comprising instructions for using said pool of assets and liabilities to perform at least one redemption transaction for said investment pool.

35. The medium of claim 33, further comprising instructions for using said pool of assets and liabilities to perform at least one subscription transaction for said investment pool.

36. The medium of claim 30, further comprising instructions for performing a reset for said investment pool in association with said amount of said assets received from said investment pool.

37. A method for managing flows of two or more investment pools, said method comprising:
selling a first security to a first investment pool having assets, wherein said rate of return of said first security is equal to a percentage of a rate of return of said first investment pool;
receiving an amount of said assets of said first investment pool as payment in exchange for said first security;
selling at least a second security to at least a second investment pool having assets, wherein a rate of return of said second security is equal to a percentage of a rate of return of said second investment pool; and,
receiving an amount of said assets of said second investment pool as payment in exchange for said second security.

38. The method of claim 37, further comprising forming a pool of assets and liabilities including at least a portion of said payments received from said first investment pool and said second investment pool.

39. The method of claim 37, further comprising using at least a portion of said payment of at least one of said investment pools for performing a subscription transaction for another of said investment pools.

40. The method of claim 37, further comprising using at least a portion of said payment of at least one of said investment pools for performing a redemption transaction for another of said investment pools.

41. The method of claim 38, wherein said pool of assets and liabilities further includes a quantity of investment securities.

42. The method of claim 38, further comprising using said pool of assets and liabilities to perform at least one redemption transaction for at least one of said first investment pool and said second investment pool.

43. The method of claim 38, further comprising using said pool of assets and liabilities to perform at least one subscription transaction for at least one of said first investment pool and said second investment pool.

44. The method of claim 37, further comprising performing a reset for at least one of said investment pools in association with said payment received from said reset investment pool.

45. A system for managing flows of two or more investment pools, said system comprising:
means for selling a first security to a first investment pool having assets, wherein said rate of return of said first security is equal to a percentage of a rate of return of said first investment pool;
means for receiving an amount of said assets of said first investment pool as payment in exchange for said first security;
means for selling at least a second security to at least a second investment pool having assets, wherein a rate of return of said second security is equal to a percentage of a rate of return of said second investment pool; and,
means for receiving an amount of said assets of said second investment pool as payment in exchange for said second security.

46. The system of claim 45, further comprising means for forming a pool of assets and liabilities including at least a portion of said payments received from said first investment pool and said second investment pool.

47. The system of claim 45, further comprising means for using at least a portion of said payment of at least one of said investment pools for performing a subscription transaction for another of said investment pools.

48. The system of claim 45, further comprising means for using at least a portion of said payment of at least one of said investment pools for performing a redemption transaction for another of said investment pools.

49. The system of claim 46, wherein said pool of assets and liabilities further includes a quantity of investment securities.

50. The system of claim 46, further comprising means for using said pool of assets and liabilities to perform at least one redemption transaction for at least one of said first investment pool and said second investment pool.

51. The system of claim 46, further comprising means for using said pool of assets and liabilities to perform at least one subscription transaction for at least one of said first investment pool and said second investment pool.

52. The system of claim 45, further comprising means for performing a reset for at least one of said investment pools in association with said payment of said reset investment pool.

53. A computer-readable medium including instructions for performing a method for managing flows of two or more investment pools, said method comprising:
selling a first security to a first investment pool having assets, wherein said rate of return of said first security is equal to a percentage of a rate of return of said first investment pool;
receiving an amount of said assets of said first investment pool as payment in exchange for said first security;
selling at least a second security to at least a second investment pool having assets, wherein a rate of return of said second security is equal to a percentage of a rate of return of said second investment pool; and,
receiving an amount of said assets of said second investment pool as payment in exchange for said second security.

54. The medium of claim 53, further comprising instructions for forming a pool of assets and liabilities including at least a portion of said payments received from said first investment pool and said second investment pool.

55. The medium of claim 53, further comprising instructions for using at least a portion of said payment of at least one of said investment pools for performing a subscription transaction for another of said investment pools.

56. The medium of claim 53, further comprising instructions for using at least a portion of said payment of at least one of said investment pools for performing a redemption transaction for another of said investment pools.

57. The medium of claim 54, wherein said pool of assets and liabilities further includes a quantity of investment securities.

58. The medium of claim 54, further comprising instructions for using said pool of assets and liabilities to perform at least one redemption transaction for at least one of said first investment pool and said second investment pool.

59. The medium of claim 54, further comprising instructions for using said pool of assets and liabilities to perform at least one subscription transaction for at least one of said first investment pool and said second investment pool.

60. The medium of claim 53, further comprising instructions for performing a reset for at least one of said investment pools in association with said payment of said reset investment pool.

61. In an investment pool, a method for managing flows of said investment pool, said method comprising:
purchasing a security from a financial service provider, said security having a rate of return equal to a percentage of a rate of return of said investment pool; and,
distributing a payment to said financial service provider in exchange for receiving said security, said payment including an amount of assets of said investment pool.

62. The method of claim 61, further comprising communicating flow information to said financial service provider, said flow information including at least net subscription information.

63. The method of claim 61, further comprising communicating flow information to said financial service provider, said flow information including at least net redemption information.

64. The method of claim 61, further comprising distributing at least a portion of said payment into a pool of assets and liabilities of said financial service provider.

65. The method of claim 64, further comprising communicating flow information in connection with said pool of assets and liabilities of said financial service provider, said flow information including at least net redemption information.

66. The method of claim 64, further comprising communicating flow information in connection with said pool of assets and liabilities of said financial service provider, said flow information including at least net subscription information.

67. The method of claim 61, further comprising receiving one of a subscription order and a redemption order in connection with a reset performed by said financial service provider.

68. In an investment pool, a system for managing flows of said investment pool, said system comprising:
means for purchasing a security from a financial service provider, said security having a rate of return equal to a percentage of a rate of return of said investment pool; and,
means for distributing a payment to said financial service provider in exchange for receiving said security, said payment including an amount of assets of said investment pool.

69. The system of claim 68, further comprising means for communicating flow information to said financial service provider, said flow information including at least net subscription information.

70. The system of claim 68, further comprising means for communicating flow information to said financial service provider, said flow information including at least net redemption information.

71. The system of claim 68, further comprising means for distributing at least a portion of said payment into a pool of assets and liabilities of said financial service provider.

72. The system of claim 71, further comprising means for communicating flow information in connection with said pool of assets and liabilities of said financial service provider, said flow information including at least net redemption information.

73. The system of claim 71, further comprising means for communicating flow information in connection with said pool of assets and liabilities of said financial service provider, said flow information including at least net subscription information.

74. The system of claim 68, further comprising means for receiving one of a subscription order and a redemption order in connection with a reset performed by said financial service provider.

75. In an investment pool, a computer-readable medium including instructions for performing a method for managing flows of said investment pool, said method comprising:
purchasing a security from a financial service provider, said security having a rate of return equal to a percentage of a rate of return of said investment pool; and,
distributing a payment to said financial service provider in exchange for receiving said security, said payment including an amount of assets of said investment pool.

76. The medium of claim 75, further comprising instructions for communicating flow information to said financial service provider, said flow information including at least net subscription information.

77. The medium of claim 75, further comprising instructions for communicating flow information to said financial service provider, said flow information including at least net redemption information.

78. The medium of claim 75, further comprising instructions for distributing at least a portion of said payment into a pool of assets and liabilities of said financial service provider.

79. The medium of claim 78, further comprising instructions for communicating flow information in connection with said pool of assets and liabilities of said financial service provider, said flow information including at least net redemption information.

80. The medium of claim 78, further comprising instructions for communicating flow information in connection with said pool of assets and liabilities of said financial service provider, said flow information including at least net subscription information.

81. The medium of claim 75, further comprising instructions for receiving one of a subscription order and a redemption order in connection with a reset performed by said financial service provider.

82. A method for assisting a plurality of mutual funds with managing flows associated with said mutual funds, said method comprising:
purchasing a security from each of said mutual funds, said security having a rate of return equal to a percentage of a rate of return of a collective investment pool; and,
distributing at least one payment to said collective investment pool in exchange for receiving said security, each said payment including an amount of assets of each of said mutual funds.

83. The method of claim 82, further comprising performing a subscription transaction for at least one of said mutual funds.

84. The method of claim 82, further comprising performing a redemption transaction for at least one of said mutual funds.

85. The method of claim 82, further comprising maintaining at least a portion of each said payment in a pool of assets and liabilities.

86. The method of claim 85, further comprising using at least a portion of said payment of at least one of said mutual funds for performing a subscription transaction for another of said mutual funds.

87. The method of claim 85, further comprising using at least a portion of said payment of at least one of said mutual funds for performing a redemption transaction for another of said mutual funds.

88. The method of claim 82, further comprising performing a reset in association with said assets of at least one of said mutual funds.

89. A system for assisting a plurality of mutual funds with managing flows associated with said mutual funds, said system comprising:
means for purchasing a security from each of said mutual funds, said security having a rate of return equal to a percentage of a rate of return of a collective investment pool; and,
means for distributing at least one payment to said collective investment pool in exchange for receiving said security, each said payment including an amount of assets of each of said mutual funds.

90. The system of claim 89, further comprising means for performing a subscription transaction for at least one of said mutual funds.

91. The system of claim 89, further comprising means for performing a redemption transaction for at least one of said mutual funds.

92. The system of claim 89, further comprising means for maintaining at least a portion of said payment in a pool of assets and liabilities.

93. The system of claim 92, further comprising means for using at least a portion of said payment of at least one of said mutual funds for performing a subscription transaction for another of said mutual funds.

94. The system of claim 92, further comprising means for using at least a portion of said payment of at least one of said mutual funds for performing a redemption transaction for another of said mutual funds.

95. The system of claim 89, further comprising means for performing a reset in association with said assets of at least one of said mutual funds.

96. A computer-readable medium including instructions for performing a method for assisting a plurality of mutual funds with managing flows associated with said mutual funds, said method comprising:
purchasing a security from each of said mutual funds, said security having a rate of return equal to a percentage of a rate of return of a collective investment pool; and,
distributing at least one payment to said collective investment pool in exchange for receiving said security, each said payment including an amount of assets of each of said mutual funds.

97. The medium of claim 96, further comprising instructions for performing a subscription transaction for at least one of said mutual funds.

98. The medium of claim 96, further comprising instructions for performing a redemption transaction for at least one of said mutual funds.

99. The medium of claim 96, further comprising instructions for maintaining at least a portion of said payment in a pool of assets and liabilities.

100. The medium of claim 99, further comprising instructions for using at least a portion of said payment of at least one of said mutual funds for performing a subscription transaction for another of said mutual funds.

101. The medium of claim 99, further comprising instructions for using at least a portion of said payment of at least one of said mutual funds for performing a redemption transaction for another of said mutual funds.

102. The medium of claim 96, further comprising instructions for performing a reset in association with said assets of at least one of said mutual funds.

103. A method for offsetting the flows of at least two mutual funds, said method comprising:
performing a redemption transaction of a first mutual fund to offset a flow of said first mutual fund; and,
using proceeds from said redemption transaction for performing a subscription transaction for a second mutual fund to offset a flow of said second mutual fund.

104. The method of claim 103, further comprising selling a security to at least one of said mutual funds; and, receiving an amount of assets of said mutual fund as payment for said security.

105. The method of claim 104, wherein a rate of return of said security is equal to a percentage of a rate of return of one of said mutual funds.

106. A system for offsetting the flows of at least two mutual funds, said system comprising:
means for performing a redemption transaction of a first mutual fund to offset a flow of said first mutual fund; and,
means for using proceeds from said redemption transaction for performing a subscription transaction for a second mutual fund to offset a flow of said second mutual fund.

107. The system of claim 106, further comprising means for selling a security to at least one of said mutual funds; and, means for receiving an amount of assets of said mutual fund as payment for said security.

108. The system of claim 107, wherein a rate of return of said security is equal to a percentage of a rate of return of one of said mutual funds.

109. A computer-readable medium including instructions for performing a method for offsetting the flows of at least two mutual funds, said method comprising:
performing a redemption transaction of a first mutual fund to offset a flow of said first mutual fund; and,
using proceeds from said redemption transaction for performing a subscription transaction for a second mutual fund to offset a flow of said second mutual fund.

110. The medium of claim 109, further comprising instructions for selling a security to at least one of said mutual funds; and, instructions for receiving an amount of assets of said mutual fund as payment for said security.

111. The medium of claim 110, wherein a rate of return of said security is equal to a percentage of a rate of return of one of said mutual funds.
